(19) United States
(12) Patent Application Publication
(10) Pub. No.: US 2024/0375115 A1
(43) Pub. Date: Nov. 14, 2024

(54) Microfluidic Device

(71) Applicants: Shin-Etsu Chemical Co., Ltd., Tokyo (JP); Shin-Etsu Engineering Co., Ltd., Tokyo (JP)

(72) Inventors: Masao ANDO, Joetsu-shi (JP); Hiroyuki YAMAZAKI, Joetsu-shi (JP); Masaki TAKEUCHI, Joetsu-shi (JP); Kazuma KAWAGOE, Tokyo (JP)

(73) Assignees: Shin-Etsu Chemical Co., Ltd., Tokyo (JP); Shin-Etsu Engineering Co., Ltd., Tokyo (JP)

(21) Appl. No.: 18/643,813

(22) Filed: Apr. 23, 2024

(30) Foreign Application Priority Data
May 10, 2023 (JP) 2023-077794

(51) Int. Cl. B01L 9/00; B01L 3/00

(52) U.S. Cl. CPC B01L 9/527; B01L 3/502715; B01L 2300/0816

(57) ABSTRACT

A microfluidic device includes: a microfluidic chip with a flow path formed inside; a cover and a base, each in contact with a surface of the microfluidic chip; a chip holder including a fixture for securing the microfluidic chip to the cover and the base; and a connector with one end in contact with a surface of the microfluidic chip and the other end serving as a fluid supply or discharge port. The flatness of the surfaces of the microfluidic chip is 50 μm or less, and the planarity of the surfaces of the cover and base is 50 μm or less. By this structure, the microfluidic chip is hardly deformed, and damage to the microfluidic chip is suppressed. In addition, liquid tightness at a connection portion with the flow path of the microfluidic chip is high, and liquid leakage hardly occurs.

### CROSS-REFERENCE TO RELATED APPLICATIONS

This non-provisional application claims priority under 35 U.S.C. § 119 (a) on Patent Application No. 2023-077794 filed in Japan on May 10, 2023, the entire contents of which are hereby incorporated by reference.

### TECHNICAL FIELD

The present invention relates to a microfluidic device suitable for microfluidic technology using a microfluidic chip.

### BACKGROUND ART

Microfluidic technology is a technology capable of handling various chemical operations and biological operations such as mixing, reaction, separation, purification, culture, measurement, and detection with an extremely small amount of sample. The microfluidic technology can be utilized in various applications by providing a microfluidic chip having a flow path called a microchannel with a functional region having various functions such as a reaction region in which a reagent is disposed. Examples of utilization of the microfluidic technology include biological substance analysis, DNA inspection, drug discovery/pharmaceutical development, environmental analysis, food quality analysis, and measuring equipment.

In recent years, microfluidic technology has been rapidly spreading also in, for example, chemical synthesis such as fine particle production and organic synthesis utilizing microfluidic technology. In fine particle production and chemical synthesis utilizing microfluidic technology, a microfluidic device is used to facilitate supply of a sample to a flow path of a microfluidic chip and discharge of the sample from the flow path. Such a microfluidic device generally includes a microfluidic chip and a chip holder for holding the microfluidic chip, and further, by connecting a tube for feeding or discharging liquid to a flow path of the microfluidic chip via a connector, it is possible to supply a sample to the flow path and discharge the sample from the flow path.

For example, JP-A 2005-270729 (Patent Document 1) discloses a chip holder for a microchemical system including: a connection portion that connects a tube to an injection port and a discharge port of a chip for a microchemical system; a placement portion on which the chip for a microchemical system is placed; and a pressing portion that presses the chip for a microchemical system placed on the placement portion using a toggle clamp to fix the chip for a microchemical system at the placed position.

In addition, WO 2011/070633 A (Patent Document 2) discloses a substrate holder including a cover and a base that sandwich a substrate, a fixture that fixes the cover and the base, and a connector that connects a flow path formed on the substrate and a liquid feeding tube that feeds liquid to the flow path, in which the connector includes a ferrule in which the liquid feeding tube can be inserted from an end surface opening of a second end portion opposite to a first end portion on a side connected to the flow path, and the liquid feeding tube inserted from the end surface opening is press-fitted and held, and a distal end portion is pressed against the substrate.

### CITATION LIST

Patent Document 1: JP-A 2005-270729
Patent Document 2: WO 2011/070633 A

### SUMMARY OF THE INVENTION

In fine particle production and chemical synthesis by microfluidic technology using a microfluidic chip, it is desirable to continuously input a sample as a fluid at a high flow rate from the viewpoint of improving productivity. However, in a case where the sample is fed at a high pressure in order to feed the sample into the microfluidic chip at a high flow rate, for example, in a configuration in which the chip for a microchemical system is pressed using a toggle clamp as described in JP-A 2005-270729 (Patent Document 1), the holding force of the liquid feeding tube is not sufficient, and thus there is concern about liquid leakage at a connection portion with the flow path of the microfluidic chip.

In addition, when a fluid sample is fed into the microfluidic chip at a high pressure, there is also a concern that the microfluidic chip may be damaged. A main factor of damage to the microfluidic chip is that a high pressure fluid gives tensile stress or compressive stress to the microfluidic chip, and the stress deforms the microfluidic chip. Furthermore, in the substrate holder described in WO 2011/070633 A (Patent Document 2), the liquid feeding tube is press-fitted and held by the connector, and the ferrule provided at the distal end portion is pressed against the microfluidic chip. However, in a case where a sample is fed at a high pressure, when the pressing force of the ferrule is excessively increased in order to avoid liquid leakage at the connection portion with the flow path, there is a concern that the microfluidic chip may be damaged. Therefore, it is necessary to suppress deformation of the microfluidic chip when a fluid sample is fed into the microfluidic chip at a high pressure.

The present invention has been made in view of the above circumstances, and an object of the present invention is to provide a microfluidic device in which a microfluidic chip is less likely to be damaged, and a microfluidic device having high liquid tightness at a connection portion with a flow path of the microfluidic chip.

As a result of intensive studies to achieve the above object, the inventors of the present invention have found that in a microfluidic device including a microfluidic chip in which a flow path is formed, a cover and a base that are in contact with a surface of the microfluidic chip, and a connector that is in contact with the surface of the microfluidic chip at an opening portion of the flow path of the microfluidic chip, the microfluidic chip is less likely to be damaged by setting the flatness of each surface of the microfluidic chip in contact with the cover and the base and the planarity of each surface of the cover and the base in contact with the microfluidic chip to a predetermined value or less, and further, the microfluidic device has high liquid tightness at a connection portion with the flow path of the microfluidic chip and the microfluidic chip is less likely to be damaged by setting the flatness of the surface of the microfluidic chip in contact with the connector to a predetermined value or less, and have completed the present invention.

Accordingly, the present invention provides the following microfluidic device.
1. A microfluidic device comprising:
a microfluidic chip with a flow path formed inside;
a chip holder; and
a connector; and configured such that
the chip holder includes a cover and a base that are in contact with a surface of the microfluidic chip and a fixture that connects the cover and the base and allows the microfluidic chip to be held between the cover and the base;
the fixture is configured to fix each of the cover and the base in close contact with the microfluidic chip;
the connector passes through one or both of the cover and the base, one end side comes in contact with the surface of the microfluidic chip at an opening portion of the flow path of the microfluidic chip, and an other end side is a fluid supply port or a fluid discharge port;
flatness of the surface of the microfluidic chip in contact with the cover and flatness of the surface of the microfluidic chip in contact with the base are both 50 μm or less; and
planarity of a surface of the cover in contact with the microfluidic chip and planarity of a surface of the base in contact with the microfluidic chip are both 50 μm or less.
2. The microfluidic device according to 1, wherein flatness of the surface of the microfluidic chip with which the connector is in contact is 50 μm or less.
3. The microfluidic device according to 1, wherein a recessed portion is formed in each of surface portions of the cover and the base on a side facing the microfluidic chip, and the microfluidic chip is fitted into each recessed portion such that a surface of the microfluidic chip and a bottom surface of the recessed portion of the cover and a surface of the microfluidic chip and a bottom surface of the recessed portion of the base are in contact with each other.
4. The microfluidic device according to 3, wherein a depth of the recessed portion is 10% or more and 50% or less of a thickness of the microfluidic chip between the surface of the microfluidic chip in contact with the bottom surface of the recessed portion of the cover and the surface of the microfluidic chip in contact with the bottom surface of the recessed portion of the base.
5. The microfluidic device according to 3, wherein a size of the recessed portion in a direction orthogonal to the depth direction is formed to be larger than a size of the microfluidic chip by 0.01 mm or more and 0.5 mm or less.
6. The microfluidic device according to 1, wherein a tube is connected to the connector.
7. The microfluidic device according to 6, wherein the connector includes a pressing member and a ring-shaped ferrule into which the tube is inserted, and the ferrule is configured to be brought into close contact with the surface of the microfluidic chip and a surface of the tube by pressing from the pressing member.
8. The microfluidic device according to 7, wherein the ferrule is formed of a resin material having a tensile strength of 20 MPa or more and 300 MPa or less.
9. The microfluidic device according to 1, wherein the microfluidic chip is formed of synthetic quartz glass.
10. The microfluidic device according to 1, wherein the cover and the base are each formed of a metallic material, a non-metallic material, or a composite material of a metal and a non-metal having a Young's modulus of 60 GPa or more.

### Advantageous Effects of the Invention

According to the present invention, even when a fluid sample is fed into a microfluidic chip at a high pressure, tensile stress and compressive stress applied to the microfluidic chip are effectively dispersed in the chip holder, and a load on the microfluidic chip itself is reduced, and thus the microfluidic chip is hardly deformed, and damage to the microfluidic chip is suppressed. In addition, liquid tightness at a connection portion with the flow path of the microfluidic chip is high, and even when a fluid sample is fed into the flow path of the microfluidic chip at a high pressure, liquid leakage hardly occurs and it becomes even more difficult for the microfluidic chip to be damaged.

### BRIEF DESCRIPTION OF THE DRAWINGS

FIG. 1 is a perspective view illustrating an example of a microfluidic device of the present invention; and

FIG. 2 is an exploded perspective view of the microfluidic device in FIG. 1.

### DETAILED DESCRIPTION OF THE INVENTION

Hereinafter, the present invention is described in more detail.

A microfluidic device of the present invention includes a microfluidic chip, a chip holder, and a connector.

### [Microfluidic Chip]

The microfluidic chip usually has a plate-like shape. From the viewpoint of ease of manufacturing, the shape of the main surface of the microfluidic chip is preferably a quadrangular shape such as a rectangle, a circular shape, or the like. The size of the main surface is not particularly limited; however, for example, in a case where the main surface has a quadrangular shape, the length of one side is preferably 10 to 1000 mm, and in a case where the main surface has a circular shape, the diameter is preferably 10 to 1000 mm. On the other hand, the thickness of the microfluidic chip is not particularly limited; however, is preferably 0.01 mm or more, more preferably 0.1 mm or more, still more preferably 0.5 mm or more, and more preferably 300 mm or less, even more preferably 100 mm or less, and still more preferably 15 mm or less. When the thickness is in such a range, the rigidity of the microfluidic chip can be secured, damage at the time of handling can be reduced, and the weight of the microfluidic chip can be reduced.

A flow path is formed inside the microfluidic chip. By forming the flow path of the microfluidic chip into a desired shape and supplying a sample (fluid such as liquid) to the flow path, various chemical operations and biological operations such as mixing, reaction, separation, purification, culture, measurement, and detection can be performed. The number of flow paths may be one, plural, or branched. Preferable examples of the cross-sectional shape of the flow path include a quadrangular shape, a circular shape, a semicircular shape, and a substantially semicircular shape. The length, width, and height of the flow path can be appropriately selected according to the application of the microfluidic chip to be used; however, the width is usually 0.01 μm or more and usually 100,000 μm or less, and the height is usually 0.01 μm or more and usually 100,000 μm or less. The height is usually formed to be about 90% or less of the thickness of the microfluidic chip.

The microfluidic chip is not particularly limited; however, is preferably formed of synthetic quartz glass from the viewpoint of long-term stability, weather resistance, chemical resistance, and the like. The synthetic quartz glass can be obtained by forming a synthetic quartz glass ingot manufactured by a conventional method into a predetermined size and thickness, and then subjecting the surface to lapping polishing, rough polishing, precision polishing, or the like as necessary.

A supply hole or a discharge hole forming a supply portion or a discharge portion of the sample in the flow path is formed in an opening portion (end portion) of the flow path of the microfluidic chip. A connector may be connected to the supply hole or the discharge hole. The supply hole and the discharge hole communicate with the flow path of the microfluidic chip, and the size thereof is not particularly limited. Preferable examples of the shape of the supply hole and the discharge hole include a circular shape and a polygonal shape. The sizes of the supply hole and the discharge hole (sizes along the main surface of the microfluidic chip) are not particularly limited; however, from the viewpoint of manufacturing or handling, the length of one side is preferably 0.1 to 5 mm in the case of a quadrangular shaped supply hole and discharge hole, and the diameter is preferably 0.1 to 5 mm in the case of the circular supply hole and discharge hole.

Although the microfluidic chip is not particularly limited, for example, the microfluidic chip may include a first substrate having a groove formed on a surface thereof and a second substrate in contact with the surface of the first substrate having the groove formed thereon, and the groove surrounded by the first substrate and the second substrate may be configured to form a flow path having an end portion opened through at least one of the first substrate and the second substrate.

[Chip holder]

The chip holder includes a cover, a base, and a fixture. The cover and the base are in contact with surfaces of the microfluidic chip (one surface and the other surface facing each other). In addition, a hole for connecting the connector to the flow path of the microfluidic chip is usually formed in one or both of the cover and the base. The hole for connecting the connector to the flow path of the microfluidic chip is usually formed at a position coinciding with the opening portion of the flow path of the microfluidic chip. As a result, the sample can be reliably supplied or discharged via the connector inserted into the hole.

The cover and the base usually have a plate shape. The shape of the main surfaces of the cover and the base, from the viewpoint of case of manufacturing, is preferably a quadrangular shape such as a rectangle, a circular shape, or the like. The main surfaces may be the same shape and size as the main surface of the microfluidic chip; however, is preferably the same shape as the main surface of the microfluidic chip and larger than the main surface of the microfluidic chip. On the other hand, the thickness of each of the cover and the base is not particularly limited; however, is preferably 1 mm or more, more preferably 3 mm or more, still more preferably 5 mm or more, and preferably 300 mm or less, more preferably 100 mm or less, still more preferably 30 mm or less. When the thickness is in such a range, rigidity of the cover and the base can be secured, damage at the time of handling can be reduced, and the weight of the entire microfluidic device can be reduced.

A recessed portion may be formed in a surface portion of each of the cover and the base on a side facing the microfluidic chip. The recessed portion can be fitted with the microfluidic chip, and in such case the surface of the microfluidic chip and a bottom surface of the recessed portion of the cover (for example, a surface having substantially the same shape as the surface of the microfluidic chip), and the surface of the microfluidic chip and a bottom surface of the recessed portion of the base (a surface having substantially the same shape as the surface of the microfluidic chip) are in contact with each other. A depth of the recessed portions of the cover and the base is preferably greater than or equal to 10%, more preferably greater than or equal to 20%, and preferably less than or equal to 50%, more preferably less than or equal to 45% of the thickness (between one surface and the other surface) of the microfluidic chip. In addition, the size of the recessed portion in the direction orthogonal to the depth direction is preferably 0.01 mm or more, more preferably 0.05 mm or more, and preferably 0.5 mm or less, more preferably 0.1 mm or less larger than the size of the microfluidic chip (the size of the main surface). In this way, alignment of the microfluidic chip is facilitated, and misalignment of the microfluidic chip can be prevented, and thus, in particular, liquid tightness at the connector portion can be excellently maintained. In addition, it is possible to prevent damage to the microfluidic chip due to excessive contact with a side surface or a peripheral surface of the recessed portion of the chip holder.

The cover and the base are each preferably formed of a metal material, a non-metal material, or a composite material of metal and non-metal. Examples of a metal material include chromium steel, stainless steel, aluminum, an aluminum alloy, titanium, and a titanium alloy, examples of a non-metal material include ceramics, and examples of a composite material of a metal and a non-metal include a fiber-reinforced metal and a fiber-reinforced plastic. Among these, stainless steel is particularly preferable from the viewpoint of case of processing, corrosion resistance, and heat resistance. In addition, the materials constituting the cover and the base are each preferably a material having a Young's modulus of preferably 60 GPa or more and preferably 500 GPa or less.

The fixture connects the cover and the base, sandwiches the microfluidic chip between the cover and the base, and fixes the microfluidic chip in close contact with the cover and the base. The fixing with the fixture is not particularly limited as long as the microfluidic chip can be firmly attached and fixed to the cover and the base; however, for example, mechanical fixing with screws is preferable. When the cover and the base are fixed with screws, through holes or non-through holes may be provided in the cover and the base, and one or both of the cover and the base may have screw shapes. In the case of mechanical fixing with screws, the pressing force on the microfluidic chip by the cover and the base can be adjusted throughout the microfluidic device by adjusting the degree of tightening of the individual screws.

### [Connector]

The connector is fixed to one or both of the cover and the base and is brought into contact with the surface of the microfluidic chip. One end side of the connector is in contact with the surface of the microfluidic chip at an end portion of the flow path of the microfluidic chip, and the other end side is a fluid supply port or a fluid discharge port. The connector can be connected to a tube (liquid feeding tube or liquid discharge tube). The shape of the connector is not particularly limited as long as the connector can be firmly fixed by being inserted into a hole formed in one or both of the cover and the base, but a screw shape is suitably used. When the shape of the connector is a screw shape, a hole for connecting to the flow path of the microfluidic chip is a screw hole (screw-shaped hole). In this manner, the connector can be reliably brought into close contact with the surface of the microfluidic chip, liquid leakage is prevented, and the sample can be reliably supplied or discharged via the connector inserted into the hole. In addition, in a case where the microfluidic chip is pressed by the connector, the microfluidic chip can be prevented from being displaced during supply or discharge of the sample.

The connector preferably includes a pressing member and a ring-shaped ferrule into which the tube is inserted. In such a connector, the ferrule can be configured to be in close contact with each of the surface of the microfluidic chip and the tube by the pressing from the pressing member, and with such a configuration, liquid tightness between the surface of the microfluidic chip and the tube can be excellently maintained. When the connector has a screw shape, the pressing member may have a screw shape.

The pressing member is preferably formed of a resin material; however, may also be formed of a metal material such as stainless steel. Examples of the resin material include PEEK, PPS, POM, PE, PP, ETFE, PCTFE, PTFE, and PFA.

The ferrule is preferably formed of a resin material. Examples of the resin material include PEEK, PP, ETFE, and PCTFE. The material constituting the ferrule is preferably a material having a tensile strength of preferably 20 MPa or more, more preferably 30 MPa or more, and preferably 300 MPa or less, more preferably 200 MPa or less. When the tensile strength of the ferrule is within such a range, the ferrule can be more reliably brought into close contact with each of the surface of the microfluidic chip and the tube by the pressing from the pressing member, and the liquid tightness can be excellently maintained.

A tube can be connected to the other end side of the connector. The tube is preferably formed of a resin material, but may also be formed of a metal material such as stainless steel. Examples of the resin material include PEEK, PTFE, and PFA.

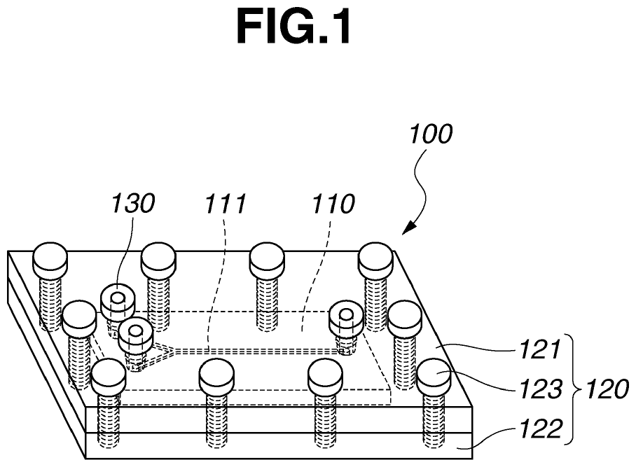

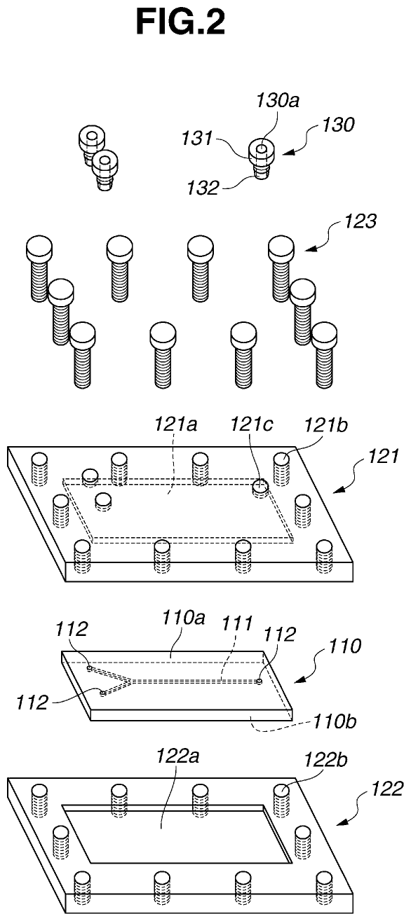

FIG. 1 is a perspective view illustrating an example of a microfluidic device of the present invention, and FIG. 2 is an exploded perspective view of the microfluidic device of FIG. 1. Note that the drawings are schematic or conceptual, and dimensions, ratios, and the like of the respective members are not limited to those illustrated, and the same members may have different dimensions, ratios, and the like.

A microfluidic device 100 illustrated in FIGS. 1 and 2 includes a microfluidic chip 110, a chip holder 120, and connectors 130. One flow path 111 branched in a Y shape is formed inside the microfluidic chip 110, and a circular supply hole or discharge hole 112 having a diameter larger than the width and height of the flow path is formed in each of three opening portions (end portions) of the flow path 111.

The chip holder 120 includes a cover 121, a base 122, and fixtures 123. In the cover 121, a recessed portion 121a is formed in a surface portion on a side facing the microfluidic chip 110, and a surface (one surface) 110a side of the microfluidic chip 110 where the flow path 111 is opened is fitted into the recessed portion 121a. Holes 121b into which the fixtures 123 are fitted are provided in an outer peripheral portion of the cover 121 where the recessed portion 121a is not formed. In this case, 10 screw-shaped fixtures 123 are used, and 10 screw-shaped holes 121b are provided in the cover 121. Further, in the portion of the recessed portion 121a of the cover 121, three screw-shaped holes 121c for connecting the connectors 130 are formed at positions corresponding to the supply holes or the discharge holes 112 formed in the opening portions of the flow path 111 of the microfluidic chip 110. In this case, three screw-shaped connectors 130 are used, and three screw-shaped holes 121c are provided.

On the other hand, also in the base 122, a recessed portion 122a is formed in a surface portion on a side facing the microfluidic chip 110, and a surface (other surface) 110b side where the flow path 111 of the microfluidic chip 110 is not opened is fitted into the recessed portion 122a. In addition, holes 122b into which the fixtures 123 are fitted are provided in an outer peripheral portion of the base 122 where the recessed portion 122a is not formed. In this case, ten screw-shaped fixtures 123 are used, and ten screw-shaped holes 122b are provided in the base 122.

The connectors 130 are fixed to the cover 121 and are in contact with the surface (one surface) 110a of the microfluidic chip 110 on which the flow path 111 is opened. One end side of the connector 130 is in contact with the surface (one surface) 110a on which the flow path 111 of the microfluidic chip 110 is opened at a portion of the supply hole or the discharge hole 112 of the microfluidic chip 110, and the other end side forms a fluid supply port or a fluid discharge port 130a. The connector 130 includes a pressing member 131 and a ferrule 132. The pressing member 131 is formed in a hollow shape so that a tube (not illustrated) can be inserted, and is formed in a screw shape. The ferrule 132 is formed in a ring shape so that a tube can be inserted. In this case, when the screw-shaped pressing member 131 is screwed into the screw-shaped hole 121c of the cover 121, the ferrule 132 is pressed by the pressing member 131, and the ferrule 132 comes into close contact with each of the surface (one surface) 110a on which the flow path 111 of the microfluidic chip 110 is opened and the tube.

In the microfluidic device 100, the microfluidic chip 110 is fitted into the recessed portion 121a and the recessed portion 122a of the cover 121 and the base 122, respectively, and the fixtures 123 are screwed into the holes 121b and the holes 122b, whereby the cover 121 and the base 122 are connected, and the microfluidic chip 110 is sandwiched between the cover 121 and the base 122. Then, the surface (one surface) 110a of the microfluidic chip 110 in which the flow path 111 is opened and the bottom surface of the recessed portion 121a of the cover 121 are in close contact with each other, and the surface (the other surface) 110b of the microfluidic chip 110 in which the flow path 111 is not opened and the bottom surface of the recessed portion 122a of the base 122 are in close contact with each other, whereby the microfluidic chip 110 is fixed.

In the microfluidic device of the present invention, the flatness of the surface of the microfluidic chip that comes in contact with the cover and the flatness of the surface of the microfluidic chip that comes in contact with the base are both 50 μm or less, preferably 30 μm or less, more preferably 20 μm or less, still more preferably 15 μm or less, and particularly preferably 10 μm or less. As the flatness, thickness variation (TTV: total thickness variation) can be applied.

In addition, the planarity of the surface of the cover that comes in contact with the microfluidic chip and the planarity of the surface of the base that comes in contact with the microfluidic chip are both 50 μm or less, preferably 30 μm or less, more preferably 20 μm or less, still more preferably 15 μm or less, and particularly preferably 10 μm or less. As the planarity, planarity defined in JIS B0621 can be applied.

By setting the flatness and planarity of each surface in this manner, even when a fluid sample is fed into the microfluidic chip at a high pressure, tensile stress and compressive stress applied to the microfluidic chip are effectively dispersed in the chip holder, and the load on the microfluidic chip itself is reduced, and thus the microfluidic chip is hardly deformed, and damage to the microfluidic chip is suppressed.

Further, the flatness of the surface of the microfluidic chip with which the connector is in contact is 50 μm or less, preferably 30 μm or less, more preferably 20 μm or less, still more preferably 15 μm or less, and particularly preferably 10 μm or less. As the flatness, a thickness variation (TTV: total thickness variation) is applied.

By setting the flatness of the surface of the microfluidic chip with which the connector is in contact in this manner, the microfluidic chip is less likely to be damaged, and further, the liquid tightness at the connection portion with the flow path of the microfluidic chip is high, and liquid leakage is less likely to occur even when a fluid sample is fed into the flow path of the microfluidic chip at a high pressure.

The flatness of the surface of the microfluidic chip and the planarity of the surfaces of the cover and the base can be obtained by polishing the surfaces of the microfluidic chip, the cover and the base. The flatness of the surface of the microfluidic chip and the planarity of the surfaces of the cover and the base may be a predetermined flatness or planarity at least at a portion where the microfluidic chip is in contact with the cover and the base, and furthermore, it is sufficient that the flatness of the surface of the microfluidic chip at the portion with which the connector is in contact be a predetermined flatness.

### Examples

Hereinafter, the present invention is described more specifically with reference to Examples and Comparative Examples; however, the present invention is not limited to the following Examples.

### Example 1 and Comparative Examples 1 and 2

A microfluidic device as shown in FIG. 1 was prepared. The microfluidic chip, the chip holder (cover, base, and fixtures), the connectors (the pressing members and the ferrules), and the tube were as follows.

The microfluidic chip was made of synthetic quartz glass having a size of 30 mm×70 mm and a thickness of 1.8 mm, and the flow path was a Y-shaped flow path (total length: 60 mm) having a maximum width of 1200 μm, a height of 300 μm, and a substantially semicircular cross-sectional shape. Each supply hole or discharge hole had a circular shape with a diameter of 1.0 mm.

The cover and the base were made of stainless steel (SUS 304) having a size of 60 mm×100 mm and a thickness of 7 mm, respectively, and the sizes of the recessed portions were 30.1 mm×70.1 mm and a depth of 0.5 mm, respectively. Each screw-shaped fixture was an M5 screw, and the number of the screw-shaped fixtures was seven unlike FIG. 1, and seven screw-shaped holes corresponding to the fixtures were formed in each of the cover and the base. In addition, each of three screw connectors was an M6 screw, and three screw holes corresponding to the connectors were formed in the cover.

The pressing member of the connector was made of PEEK, and the ferrule was made of PTFE. In addition, the tube was made of PEEK.

The flatness of the surfaces of the microfluidic chip facing the cover and the base, the planarity of the surfaces of the cover and the base facing the microfluidic chip, and the flatness of the surface of the microfluidic chip with which the connector (ferrule) come in contact were as shown in Table 1.

TABLE 1

| | | | Comparative | Comparative |
|---|---|---|---|---|
| | | Example 1 | Example 1 | Example 2 |
| Flatness of | Surface in contact | 10 | 100 | 10 |
| microfluidic | with cover | | | |
| chip [μm] | Surface in contact | 10 | 100 | 10 |
| | with base | | | |
| | Surface in contact | 10 | 100 | 10 |
| | with connector | | | |

| | | | |
|---|---|---|---|
| Planarity of surface | 10 | 10 | 100 |
| of cover [μm] | | | |
| Planarity of surface | 10 | 10 | 100 |
| of base [μm] | | | |

The microfluidic chip was fitted into the recessed portion of each of the cover and the base, the fixtures were screwed into the holes to connect the cover and the base, and the microfluidic chip was sandwiched and fixed between the cover and the base. In addition, tubes were inserted into the pressing members and the ferrules, the ferrules were inserted into the holes, the pressing members were screwed into the holes of the cover to press the ferrules, and the connectors were fixed to the cover and brought into contact with the surface of the microfluidic chip.

Pure water was fed to the flow path of the microfluidic chip through the tubes at a liquid feeding pressure of 3 MPa using a plunger pump. In Example 1, liquid leakage and damage to the microfluidic chip were not confirmed. In Comparative Example 1, liquid leakage was confirmed at the contact portions between the microfluidic chip and the connectors. In Comparative Example 2, damage to the microfluidic chip was confirmed.

Japanese Patent Application No. 2023-077794 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A microfluidic device comprising:
a microfluidic chip with a flow path formed inside;
a chip holder; and
a connector; and configured such that
the chip holder includes a cover and a base that are in contact with a surface of the microfluidic chip and a fixture that connects the cover and the base and allows the microfluidic chip to be held between the cover and the base;
the fixture is configured to fix each of the cover and the base in close contact with the microfluidic chip;
the connector passes through one or both of the cover and the base, one end side comes in contact with the surface of the microfluidic chip at an opening portion of the flow path of the microfluidic chip, and an other end side is a fluid supply port or a fluid discharge port;
flatness of the surface of the microfluidic chip in contact with the cover and flatness of the surface of the microfluidic chip in contact with the base are both 50 μm or less; and
planarity of a surface of the cover in contact with the microfluidic chip and planarity of a surface of the base in contact with the microfluidic chip are both 50 μm or less.

2. The microfluidic device according to claim 1, wherein flatness of the surface of the microfluidic chip with which the connector is in contact is 50 μm or less.

3. The microfluidic device according to claim 1, wherein a recessed portion is formed in each of surface portions of the cover and the base on a side facing the microfluidic chip, and the microfluidic chip is fitted into each recessed portion such that the surface of the microfluidic chip and a bottom surface of the recessed portion of the cover and the surface of the microfluidic chip and a bottom surface of the recessed portion of the base are in contact with each other.

4. The microfluidic device according to claim 3, wherein a depth of the recessed portion is 10% or more and 50% or less of a thickness of the microfluidic chip between the surface of the microfluidic chip in contact with the bottom surface of the recessed portion of the cover and the surface of the microfluidic chip in contact with the bottom surface of the recessed portion of the base.

5. The microfluidic device according to claim 3, wherein a size of the recessed portion in a direction orthogonal to the depth direction is formed to be larger than a size of the microfluidic chip by 0.01 mm or more and 0.5 mm or less.

6. The microfluidic device according to claim 1, wherein a tube is connected to the connector.

7. The microfluidic device according to claim 6, wherein the connector includes a pressing member and a ring-shaped ferrule into which the tube is inserted, and the ferrule is configured to be brought into close contact with the surface of the microfluidic chip and a surface of the tube by pressing from the pressing member.

8. The microfluidic device according to claim 7, wherein the ferrule is formed of a resin material having a tensile strength of 20 MPa or more and 300 MPa or less.

9. The microfluidic device according to claim 1, wherein the microfluidic chip is formed of synthetic quartz glass.

10. The microfluidic device according to claim 1, wherein the cover and the base are each formed of a metallic material, a non-metallic material, or a composite material of a metal and a non-metal having a Young's modulus of 60 GPa or more.
